(19) United States
(12) Patent Application Publication
(10) Pub. No.: US 2026/0115630 A1
(43) Pub. Date: Apr. 30, 2026

(54) FILTRATION APPARATUS

(71) Applicant: NIHON GENRYO Co., Ltd., Kawasaki-shi, Kanagawa (JP)

(72) Inventor: Yasuhiro SAITO, Kawasaki-shi, Kanagawa (JP)

(73) Assignee: NIHON GENRYO Co., Ltd., Kawasaki-shi, Kanagawa (JP)

(21) Appl. No.: 19/120,790

(22) PCT Filed: Oct. 5, 2023
(86) PCT No.: PCT/JP2023/036431

§ 371 Date: Apr. 14, 2025

(30) Foreign Application Priority Data
Oct. 17, 2022 (JP) 2022-166084

(51) Int. Cl. B01D 24/46; B01D 24/16

(52) U.S. Cl. CPC B01D 24/4605; B01D 24/165; B01D 24/4631

(57) ABSTRACT

A filtration apparatus includes: a filtration tank; a layer of filter medium disposed in an interior of the filtration tank, the layer of filter medium being used to pass supplied raw water therethrough from bottom to top to filter the raw water; and a filter medium washing device having a helical screw placed upright in the layer of filter medium and a screw driving unit configured to rotate the screw about a screw axis, the filter medium washing device being configured to rotate the screw to scrub and wash the filter medium. The filter medium washing device, which does not include an outer cylinder surrounding the screw, is further configured to transport the filter medium upward in a state in which an outer peripheral edge of the screw is in direct contact with the layer of filter medium.

### CROSS-REFERENCE TO RELATED APPLICATIONS

This application is a National Phase Entry of PCT International Application No. PCT/JP2023/036431 filed on Oct. 5, 2023, which claims priority under 35 U.S.C § 119(a) to Japanese Patent Application No. 2022-166084 filed on Oct. 17, 2022. Each of the above applications is hereby expressly incorporated by reference, in its entirety, into the present application.

### TECHNICAL FIELD

The present disclosure relates to a filtration apparatus using a filter medium to pass raw water therethrough and purify the raw water.

### BACKGROUND ART

Conventionally, filtration apparatuses for filtering and purifying raw water are known, as disclosed, for example, in Japanese Unexamined Patent Publication Nos. 2004-121885 and 2004-160432. Such a filtration apparatus generally includes a layer of filter medium in a filtration tank made of a metal or other material and is configured to pass supplied raw water through the layer of filter medium to filter the raw water. Since the filter medium in this type of filtration apparatus is expected to be loaded with fine suspended solids and/or other materials that have been trapped therein after repeated use of the filtration apparatus, the filter medium needs to be disposed of or washed as appropriate. Conventionally, the filter medium may generally be washed through surface washing and/or backflow washing. Surface washing uses a nozzle to jet a stream of water onto the surface of the filter medium layer to wash it. Backflow washing includes injecting purified water into the filter medium layer from below to scrub and wash the filter medium.

However, it has been found that surface washing and backflow washing as described above do not provide much cleaning effect and rely on long cleaning times. To solve these problems, filter medium washing devices using a screw conveyor to wash filter medium have been previously proposed and put into practical use by the present applicant, as disclosed, for example, in Japanese Unexamined Patent Publication Nos. 2004-121885 and 2004-160432. These filter medium washing devices basically include a helical screw (more specifically, screw blade(s)) placed upright in the layer of filter medium, and a screw driving unit configured to rotate the screw about the screw axis, and the filter medium washing devices are configured to rotate the screw to scrub and wash the filter medium as it transports the filter medium upward from the bottom.

Referring now to FIG. 6, the device disclosed in Japanese Unexamined Patent Publication No. 2004-121885 will be described in detail, as an example of a filter medium washing device using the screw conveyor as described above. A filtration apparatus 1 including such a filter medium washing device 14 disposed therein is described first. Note that FIG. 6 may depict some elements schematically, for example, using a single straight line to indicate the cross section of a thick member. As depicted in the schematic side view of FIG. 6, the filtration apparatus 1 includes an approximately cylindrical filtration tank 2, a filter bed 4, and a filter medium 6. The filtration tank 2 has closed upper and lower ends. The filter bed 4 has a large number of micropores (not shown) and is disposed in the lower inside part of the filtration tank 2. The filter medium 6 is stacked on the filter bed 4. The filtration tank 2 is placed on a floor 10 via a plurality of support legs 8 (only one of which is shown) attached to the filtration tank 2. In addition, a plurality of short columnar filters 12 made of microporous ceramic are disposed on the filter bed 4. These filters 12 allow only purified water 16 to percolate therethrough to below the filter bed 4.

The filter medium washing device 14 is mounted to a circular mounting opening 22 formed in the center of an upper wall 20 of the filtration tank. The peripheral edge of the mounting opening 22 is formed as a mounting rim 24. A pedestal 28 is mounted on the rim 24, and a motor 26 and a reduction gear mechanism 27 are mounted on the pedestal 28. A retainer 36 is formed in the pedestal 28. The retainer 36 has three bearings 30 at their respective locations, and these three bearings 30 are configured to rotatably support a rotary axis 34 of a screw conveyor 32 without wobbling.

The filter medium washing device 14 includes a circular cylindrical member 38, which constitutes the main body of the washing tank in the filter medium washing device 14. The cylindrical member 38 has a circular disk-shaped partition wall 29 in the upper portion thereof. The partition wall 29 has a flange 31 along its outer periphery, and the flange 31 is mounted onto the rim 24 and bolted to the rim 24 together with the pedestal 28. In this way, the upper portion of the cylindrical member 38 is mounted onto the rim 24, and substantially the entirety of the cylindrical member 38 is suspended from the upper wall 20. A hole 33 is formed in the middle of the flange 31 and is adapted to receive the retainer 36 to provide a tight fit with the retainer 36. This allows the interior of the filtration tank 2 to remain sealed during filtration.

The cylindrical member 38 includes an open circular lower opening 40. The cylindrical member 38 also includes a plurality of upper openings 42 in the upper portion thereof. The plurality of upper openings 42 each extending in the vertical direction are formed at predetermined intervals in the circumferential direction of the cylindrical member 38. The lower opening 40 is positioned with respect to the filter medium 6 such that the lower opening 40 is located in the filter medium 6. The screw conveyor 32 is disposed in the interior of the cylindrical member 38. The screw conveyor 32 includes the rotary axis 34 and a screw blade 43. The rotary axis 34 has an upper portion and a lower portion which have different diameters from each other and has, for example, a hollow pipe shape. The screw blade 43 has a helical shape and is fixed to the outer peripheral surface of the lower portion (larger diameter portion) of the rotary axis 34. The screw blade 43 is formed to extend to the lower end 44 of the rotary axis 34.

The upper end of the rotary axis 34 of the screw conveyor 32 is coupled to the reduction gear mechanism 27 of the motor 26 via a joint 52. Thereby, the screw blade 43 is placed in the cylindrical member 38 such that the upper end of the screw blade 43 is located near the lower edge 42a of the upper opening 42. The screw conveyor 32 has a lower end portion 35 protruding downward from the lower opening 40 of the cylindrical member 38 such that the lower end 44 of the rotary axis 34 is located near the filter bed 4. During the process of washing the filter medium 6, this arrangement allows even the filter medium 6 that have been located near the filter bed 4 to be efficiently transported upward and washed by the screw blade 43.

The filtration tank 2 has a curved bottom wall 58 provided with a purified water discharge pipe 60 attached to the center of the bottom wall 58 and extending downward. The water that has been purified through the filter medium 6, the filter bed 4, and the filters 12 is discharged through the purified water discharge pipe 60. On the right side of FIG. 6, the filtration tank 2 is provided with a raw water inlet (turbidity discharge portion) 62 and a water level adjustment port 64 disposed below the raw water inlet 62. During the filtration process, raw water, i.e., unfiltered water 16, is injected into the filtration tank 2 through the raw water inlet 62. The water level adjustment port 64 serves as a discharge port for discharging water 16 in order to adjust the water level to the optimum level for washing the filter medium 6.

The filtration tank 2 further includes an inspection port 68 disposed in the upper wall 20. The inspection port 68 may be used to check the condition of the interior of the filtration tank 2, such as the upper surface 66 of the filter medium 6. On the left side of FIG. 6, the filtration tank 2 further includes an air vent valve 70 disposed in the upper wall 20. In addition, a filter medium input port 72 for introducing the filter medium 6 into the filtration tank 2 is disposed on the side of the filtration tank 2.

The filtration process and the filter medium washing process in the filtration tank 2 will now be described. First, the raw water to be filtered is pumped by a pump (not shown) and injected through the raw water inlet 62. As the water level 74 rises, air in the filtration tank 2 is vented through the air vent valve 70. The water level 74 may be set to reach an upper portion of the filtration tank 2 above the raw water inlet 62, i.e., adjusted so that substantially the entire filtration tank 2 may be filled with water (raw water) 16. The water level 74 depicted in FIG. 6 is indicative of a water level during ongoing injection prior to reaching the full water level. Water 16 permeates the filter medium 6 outside the cylindrical member 38 as well as enters the cylindrical member 38 through the upper openings 42 and permeates the filter medium 6 inside the cylindrical member 38. Thus, filtration can be performed even within the cylindrical member 38. The water that has been permeated and filtered through the filter medium 6 is discharged to the outside through the purified water discharge pipe 60 at the bottom of the filtration tank 2 and is ready to use.

A method of using the filter medium washing device 14 to wash the filter medium 6 which has been blinded after long-term use will now be described. First, the motor 26 is driven to rotate the screw conveyor 32, and a blade 43 of the screw conveyor 32, in particular a portion of the blade 43 exposed below the cylindrical member 38, forces the filter medium 6 upward into the cylindrical member 38. The particles of the filter medium 6 that have been forced upward may be rubbed, scrubbed, and washed against each other as they are transported upward by the rotation of the blade 43 before being discharged into the filtration tank 2 through the upper openings 42. The impact on the filter medium 6 caused by its falling onto the surface of water 16 promotes the separation of the turbidity from the filter medium 6. Then, the fallen filter medium 6 are forced upward back into the cylindrical member 38 and again rubbed and washed therein by the blade 43. In this manner, the filter medium 6 are repeatedly washed within the cylindrical member 38 to separate the contaminants therefrom. As described above, the lower end 44 of the screw conveyor 32 is located near the filter bed 4, so that even particles of the filter medium 6 located near the filter bed 4 can be forced upward and thus all the particles of the filter medium 6 may be washed equally.

The filter medium washing device as described above provides an advantageous effect that enables efficient cleaning of blinded filter medium in as little as 7 minutes, compared to 15 minutes, for example, required by conventional surface washing and backflow washing. The foregoing description has been given using an example in which the filter medium washing device is used in a filtration tank. However, filter basins such as those disclosed in Japanese Unexamined Patent Publication No. 2000-350994 are also known, and the filter medium washing device described above can also be used in such basins, allowing efficient cleaning of the filter medium in a short time as well.

### SUMMARY

Conventionally, it has been believed that the screw conveyor described above needs to include a cylindrical member (outer cylinder) extending in the longitudinal axis direction of the screw and disposed to surround the screw from radially outside. However, such a cylindrical member needs to be precisely shaped such that its inner peripheral surface maintains a predetermined distance from the outer peripheral edge of the screw, and the cylindrical member also needs to be sturdily built enough not to be broken by rubbing against the filter medium as they are transported by the screw. In view of the foregoing, conventional filter medium washing devices using a screw conveyor still in need of improvement to be cost effective and lightweight.

The present disclosure has been made in view of the foregoing circumstances and is directed to providing a filter medium washing device which can be manufactured with a low-cost and lightweight construction, and thereby to providing a filtration apparatus which can be manufactured with a low-cost and lightweight construction.

A filtration apparatus according to the present disclosure is a so-called upflow filtration apparatus comprising:
a filtration tank;
a layer of filter medium disposed in an interior of the filtration tank, the layer of filter medium being used to pass supplied raw water therethrough from bottom to top to filter the raw water; and
a filter medium washing device having a helical screw placed upright in the layer of filter medium and a screw driving unit configured to rotate the screw about a screw axis, the filter medium washing device being configured to rotate the screw to scrub and wash the filter medium,
wherein the filter medium washing device is further configured to transport the filter medium upward in a state in which an outer peripheral edge of the screw is in direct contact with the layer of filter medium, and
wherein the raw water is filtered at a filtration flow rate of 10 to 40 m/h.

The above description “in a state in which an outer peripheral edge of the screw is in direct contact with the layer of filter medium” means that a cylindrical member located radially outside the screw is not provided and thus the filtration apparatus is not configured to allow the filter medium to enter the space between the screw and the cylindrical member such that the filter medium in the space may come into contact with the outer peripheral edge of the screw, i.e., meaning that the filtration apparatus does not include such a cylindrical member. It is most desirable that such a cylindrical member is not provided over the entire length of the screw. However, the present disclosure is not limited to this, and the absence of the cylindrical member may cover only a portion of the entire length of the screw.

Regarding the screw placed upright in the layer of filter medium in the filter medium washing device of the filtration apparatus according to the present disclosure, it is most preferable that the screw be placed upright in the vertical direction. However, the present disclosure is not limited to this and the screw may be placed at a slight angle to the vertical. In such cases, an angle of inclination of up to about 10° (degrees) is desirable.

In the filter medium washing device used in the filtration apparatus of the present disclosure, it is desirable that the screw includes a plurality of helical screw blades that are not continuous with each other and that are spaced apart from each other in a screw axial direction. Furthermore, it is desirable that the screw has a coil spring shape. Specifically, the term “coil spring shape” indicates that the screw is shaped such that, when viewed from the screw axial direction (the direction in which the rotary axis of the screw extends), the helical screw blade(s) constituting the screw forms annular rings located radially outside the rotary axis of the screw.

The present inventor has first discovered that in a process of using a rotating screw to scrub and wash the filter medium as it transports the filter medium upward, the filter medium can be satisfactorily transported and washed even without the cylindrical member as described above. Based on this discovery, in the filtration apparatus according to the present disclosure, the filter medium washing device does not include the cylindrical member. Thus, the filtration apparatus according to the present disclosure may be manufactured with a low-cost and lightweight construction achieved by eliminating the cylindrical member, while maintaining the same filter medium cleaning effect as the conventional device. This advantage will be most remarkable when the cylindrical member is not provided over the entire length of the screw.

Furthermore, by including the filter medium washing device having the filter medium cleaning effect as described above, the filtration apparatus according to the present disclosure can also prevent pieces of filter medium from sticking together. This can be achieved by operating the filter medium washing device to wash the filter medium as necessary between filtration processes. Thus, even though the filtration apparatus uses an upflow filtration method, which is likely to cause pieces of filter medium to stick together, the filtration apparatus is capable of filtering even highly turbidity raw water satisfactorily even at a filtration flow rate as high as 10 to 40 m/h.

### BRIEF DESCRIPTION OF THE DRAWINGS

FIG. 1 A schematic side view of a filtration apparatus according to a first embodiment of the present disclosure;

FIG. 2 A plan view depicting a part of a filter medium washing device included in the filtration apparatus of FIG. 1;

FIG. 3 A schematic side view of a filtration apparatus according to a second embodiment of the present disclosure;

FIG. 4 A photograph of a filter medium being washed by the filter medium washing device of the filtration apparatus of FIG. 1;

FIG. 5 A photograph of a filter medium being washed by the filter medium washing device of the filtration apparatus of FIG. 3;

FIG. 6 A schematic side view of an example of a conventional filtration apparatus; and

FIG. 7 A schematic side view of a filtration apparatus according to a third embodiment of the present disclosure.

### DESCRIPTION OF EMBODIMENTS

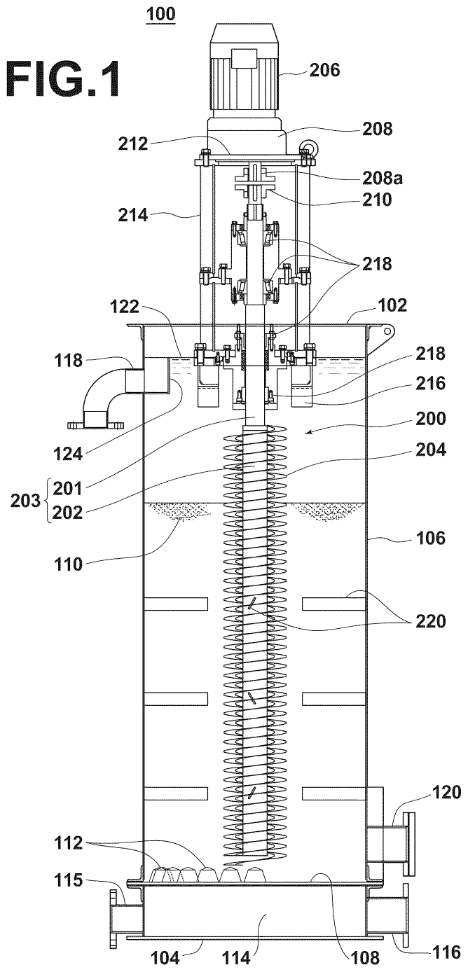

Hereinafter, embodiments of the present disclosure will be described with reference to the drawings. FIG. 1 depicts a side view schematic of a filtration apparatus 100 according to a first embodiment of the present disclosure. FIG. 1 may depict some elements schematically, for example, using a single straight line to indicate the cross section of a thick member. As depicted in the side view schematic of FIG. 1, the filtration apparatus 100 includes an approximately cylindrical filtration tank 106, a filter bed 108, and a filter medium 110. The filtration tank 106 has a top member 102 and a bottom wall 104 each surrounding a circular opening of the filtration tank 106. The filter bed 108 has a large number of micropores (not shown) and is disposed in the lower inside part of the filtration tank 106. The filter medium 110 is made of sand or other material having a greater specific gravity than water and stacked on the filter bed 108. In addition, a plurality of short columnar strainers 112 made of microporous ceramic or other material are disposed on the filter bed 108.

As an example, the filtration apparatus 100 may be a so-called upflow filtration apparatus, which has a raw water inflow chamber 114 defined between the filter bed 108 and the bottom wall 104 in the interior of the filtration tank 106. The raw water inflow chamber 114 is connected to a raw water inlet pipe 115 and a backwash water inlet pipe 116. The raw water inlet pipe 115 opens at a location on the left side of FIG. 1 which is closer to the peripheral wall of the raw water inflow chamber 114. The backwash water inlet pipe 116 opens at a location on the right side of FIG. 1 which is closer to the peripheral wall of the raw water inflow chamber 114. The filtration tank 106 is connected to a treated water outlet pipe 118 at a position slightly below the top member 102. The treated water outlet pipe 118 communicates with the interior of the filtration tank 106. The filtration tank 106 is also connected to a filter medium discharge port 120 that opens to the interior of the filtration tank 106 at a position slightly above the filter bed 108. Additionally, the filtration apparatus 100 may also be provided with a horizontal cleaning outlet pipe which opens to the interior of the raw water inflow chamber 114, a water level adjustment outlet pipe connected to the cleaning outlet pipe from above, and/or the like, none of which are, however, depicted or described herein since these are not directly related to the present disclosure and may be formed in the same manner as in conventional apparatuses. A filter medium washing device 200 is mounted at the center of the filtration tank 106. The filter medium washing device 200 will be described in more detail later.

In this filtration apparatus 100, raw water to be filtered is fed through the raw water inlet pipe 115 into the raw water inflow chamber 114 at a predetermined pressure. The raw water passes through the plurality of strainers 112 and then through the layer of filter medium 110 from bottom to top. During this process, contaminants contained in the raw water may be trapped by the filter medium 110 and the raw water may be filtered. The filtered, treated water 122 overflows a weir plate 124 before being discharged from the filtration tank 106 through the treated water outlet pipe 118.

The filter medium washing device 200 will now be further described. The filter medium washing device 200 has a rotary axis 203 that extends vertically through the center of the filtration tank 106, and helical screw blades 204 fixed to the outer peripheral surface of the rotary axis 203. The rotary axis 203 includes an upper axis portion 201 having a smaller diameter and a lower axis portion 202 having a larger diameter. Specifically, the screw blades 204 are fixed to the outer peripheral surface of the lower axis portion 202. The rotary axis 203 and screw blades 204 collectively form a screw conveyor. The screw blades 204 in this embodiment include two screw blades that are not continuous with each other and that are spaced apart from each other in the screw axial direction.

A motor 206 and a reduction mechanism section 208 configured to decelerate the rotation of the motor 206 are disposed at the top of the filtration tank 106. The motor 206 and reduction gear mechanism 208 collectively form a screw driving unit, and an output axis 208a of the reduction gear mechanism 208 is connected to the upper axis portion 201 of the rotary axis 203 via a joint 210. The motor 206 and reduction gear mechanism 208 are integrated and retained on a retaining member 212. The retaining member 212 is fixed to the filtration tank 106 via a plurality of supports 214 extending vertically and via a support 216 fixed to the inner side of the top of the filtration tank 106. In the configuration described above, the screw conveyor including the rotary axis 203 and the screw blades 204 is suspended into the filter medium 110 at the center of the filtration tank 106.

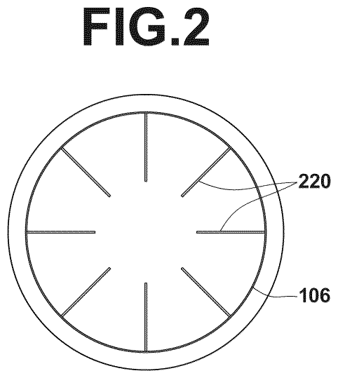

The upper axis portion 201 of the rotary axis 203 is rotatably supported by bearings 218, for example four bearings 218, which are spaced apart from each other in the axial direction. This allows the rotary axis 203 to rotate without wobbling. The filtration tank 106 includes sets of filter medium flow prevention plates 220 in the interior thereof. As can be seen in the horizontal cross-sectional view of FIG. 2 which depicts one of these sets of filter medium flow prevention plates 220, eight filter medium flow prevention plates 220 per set surround the screw blades 204 from the respective radially outside locations. As an example, three sets of these filter medium flow prevention plates 220 may be provided, with the sets being spaced apart from each other in the direction in which the helical turns of each screw blade 204 are repeated, i.e., in the axial direction of the rotary axis 203. Each filter medium flow prevention plate 220 is inclined with respect to that axial direction, such that adjacent sets of the filter medium flow prevention plates 220 may be inclined in opposite directions.

The operations of the filter medium washing device 200 will now be described. When raw water is filtered through the filter medium 110 as described above, the contaminants contained in the raw water are trapped by the filter medium 110. As such, in order to allow continuous use of the filter medium 110 instead of disposing of it, these contaminants need to be removed from the filter medium 110, i.e., the filter medium 110 needs washing, when necessary. As one of such filter medium washing processes, the filtration apparatus 100 of this embodiment performs a process called backflow washing (backwashing). During backwashing, which is performed while filtration of raw water is stopped, purified water is fed as backwash water through the backwash water inlet pipe 116 into the raw water inflow chamber 114 at a predetermined pressure. The purified water passes through the filter medium 110 from bottom to top before being discharged from the filtration tank 106 through the treated water outlet pipe 118. During this process, the contaminants that have been trapped by the filter medium 110 are separated from the filter medium 110 by the purified water and discharged from the filtration tank 106 through the treated water outlet pipe 118 together with the purified water.

In addition to this backwashing, filter medium washing using the filter medium washing device 200 may be performed as appropriate. During the filter medium washing using the filter medium washing device 200, which is performed while filtration of raw water is stopped and the backwashing is being performed, the motor 206 is driven such that its rotational force may be transmitted to the rotary axis 203 of the screw conveyor through the reduction gear mechanism 208. As the rotary axis 203 rotates, the helical screw blades 204 rotate and the filter medium 110 is transported upward by the screw blades 204. During this process, the pieces of the filter medium 110 are rubbed against each other, separating the trapped contaminants from the filter medium 110. In this process as well, the separated contaminants are discharged from the filtration tank 106 through the treated water outlet pipe 118 together with the backwash water.

Unlike conventional screw conveyors configured to scrub and wash filter medium, the screw conveyor of this embodiment is not provided with any cylindrical member (outer cylinder) surrounding the screw blades 204 from radially outside. Thus, in this embodiment, the filter medium 110 is scrubbed and washed in a state in which the outer peripheral edge of the screw, more specifically the outer peripheral edges of the screw blades 204 are in direct contact with the layer of filter medium 110. In this regard, the screw conveyor of this embodiment is unlike conventional screw conveyors including a cylindrical member located radially outside the screw blades 204 and configured to allow the filter medium 110 to enter the space between the cylindrical member and the screw such that the filter medium 110 in this space may come into contact with the outer peripheral edges of the screw blades 204.

The present inventor's study has revealed that even without such a cylindrical member, the screw blades 204 can function as a component of the screw conveyor and the filter medium 110 can be scrubbed and washed as it is transported upward by the rotating screw blades 204. It is believed that this operation can be given by the following.

As the screw blades 204 continue to rotate within the layer of filter medium 110, portions of the filter medium 110 that are in contact with the outer peripheral edges of the screw blades 204 are ground off, creating a substantially columnar space within the layer of filter medium 110. In other words, the screw blades 204 rotate within the space with their outer peripheral edges facing the periphery of this space. In some implementations where the filter medium 110 is composed primarily of sand, the periphery of this space acts as a wall that may be referred to as a “sand wall,” and functions as if it were a cylindrical member (outer cylinder) in conventional devices. As a result, pieces of the filter medium 110 that have been scattered outward by the centrifugal force generated by the rotation of the screw blades 204 hit this “sand wall” and bounce back onto the upper faces of the screw blades 204. Thus, in this configuration as well, the filter medium 110 may be scrubbed and washed as it is transported upward by the screw blades 204.

Note that although it functions like a cylindrical member (outer cylinder) of conventional devices as described above, the periphery of the space (in which the screw blades 204 rotate) is formed from the sandy filter medium 110, and thus also has the properties inherent in sandy materials. Accordingly, when pieces of the filter medium 110 are scattered radially outward with respect to the screw blades 204 and hit the periphery of the space as described above, the periphery may be slightly deformed but the scattered pieces of the filter medium 110 will not be crushed. In contrast, in conventional devices having a cylindrical member (outer cylinder) surrounding the screw blade(s) from radially outside, when pieces of the filter medium are scattered radially outward with respect to the screw blade(s) and hit the cylindrical member, the pieces of the filter medium may be crushed against the cylindrical member, which is made of metal or other material.

Since the filter medium washing device 200 in this embodiment does not include a cylindrical member as in conventional devices, the filter medium washing device 200 can be manufactured at a lower cost and lighter weight than conventional devices. In particular, the provision of cylindrical members as described above tends to be costly since such cylindrical members may be typically made of stainless steel or other metal, and the distance between the cylindrical member and the screw blade(s) may need to be precisely set to a predetermined value in order to prevent pieces of the filter medium from being caught and crushed between the inner peripheral surface of the cylindrical member and the screw blade while they are being scrubbed and washed. Thus, eliminating such a cylindrical member will result in particularly significant cost savings. In addition, it is understood that reducing the weight of the filter medium washing device 200 will also reduce the weight of the filtration apparatus 100 including the filter medium washing device 200.

Furthermore, weight reduction achieved by eliminating a, typically metal, cylindrical member as described above may be advantageous for increasing the length of the filtration tank 106. This is because a weight limit may be set for the screw conveyor and thus such a weight reduction may allow for increasing the overall lengths of the rotary axis 203 and the screw blades 204 that are included in the screw conveyor.

Additionally, in this embodiment, three sets of eight filter medium flow prevention plates 220 are disposed to surround the screw blades 204 from the respective radially outside locations. This may provide the following effects. Continuous filtration of raw water contaminated with turbidity (contaminants) through filter medium layer (the layer of filter medium 110) will cause the filter medium layer to get gradually blinded by the turbidity from bottom to top over time. As a result, the filter medium layer will suffer from additional pressure during filtration processes. As the filter medium layer gets more blinded and filtration pressure increases, the turbidity becomes integrated with the filter medium 110 in a lower portion of the layer, and this further increases the filtration pressure. Then, the lump of the integrated filter medium 110 and turbidity may be moved upward away from the filter medium layer, leaving a space (water space) in the layer, and the floating lump of the filter medium 110 and turbidity may eventually collapse into pieces and flow within the tank, which means that trapped turbidity has been dislodged into the water. This would prevent proper filtration and may lead to an unwanted situation where turbidity gets released in short bursts into the treated water 122 that has already been processed through filtration. In contrast, in this embodiment, the sets of filter medium flow prevention plates 220 may prevent such flowing and/or floating of the filter medium 110, thereby avoiding the occurrence of unwanted situations as described above.

The processing capacity of the filtration apparatus 100 in this embodiment will now be described. The filtration tank 106 included in the filtration apparatus 100 has an inner diameter of 700 mm. The filter medium 110, which is substantially composed of sand, has a filtration area of 0.385 mm². The rotational speed of the screw blades 204 during the filter medium washing process was set to 375 rpm. Under these conditions, raw water having a relatively high turbidity of 1000 degrees was filtered using the filtration apparatus 100, and it was found that the filtration even at the filtration flow rate of 30 m/h produced sufficiently clean treated water 122. The filtration flow rate of 30 m/h means that water can be processed at 11.55 m³/h.

Conventionally, when an upflow filtration apparatus is used to filter raw water having a relatively high turbidity of about 1000 degrees, it was considered difficult to produce clean treated water by operating the filtration apparatus at a high filtration flow rate, and the filtration flow rate needs to be limited to, at most, slightly less than 10 m/h. This is primarily due to the tendency for pieces of filter medium to stick together after continuous washing and reuse of the medium.

However, the present inventor has found that by using a filter medium washing device including a screw conveyor without a cylindrical member (outer cylinder) as in this embodiment, it is possible to produce sufficiently clean treated water from raw water even at a filtration flow rate as high as 10 to 40 m/h. It is believed that the effect of enabling such a high-speed filtration may be mainly because this embodiment avoids the water jetting (leakage) of raw water from the screw blade(s), which is likely to occur in conventional screw conveyors having a cylindrical member. As described above, the filtration apparatus 100 in this embodiment has both a high filtration flow rate and a high filter medium washing capacity provided by the filter medium washing device 200 having a screw conveyor without a cylindrical member.

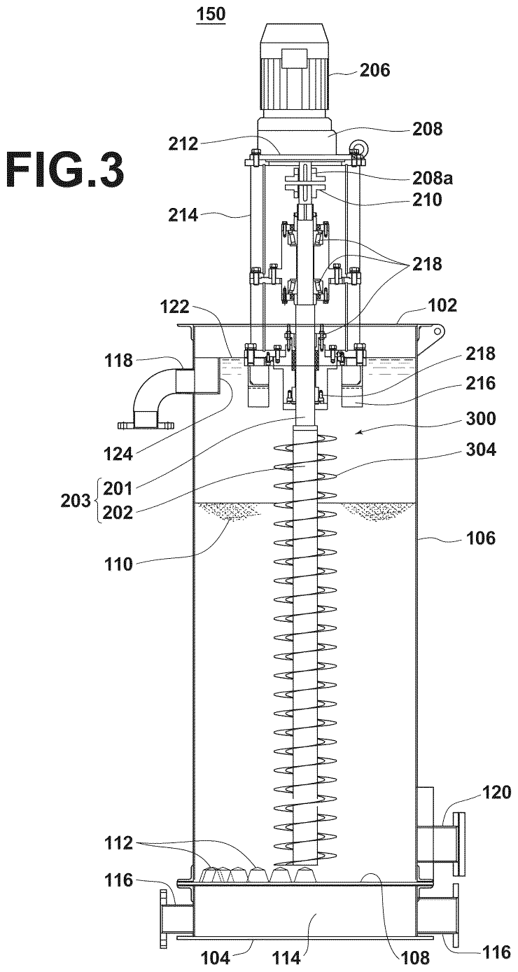

Referring now to FIG. 3, a filter medium washing device 300 disposed in a filtration apparatus 150 according to a second embodiment of the present disclosure will be described. This filter medium washing device 300 differs from the filter medium washing device 200 according to the first embodiment basically only in that a screw blade 304 of the filter medium washing device 300 includes a single screw blade, whereas the screw blades 204 of the filter medium washing device 200 include two screw blades. Also, the filtration apparatus 150 including the filter medium washing device 300 differs from the filtration apparatus 100 in FIG. 1 only in that the filtration apparatus 150 uses the filter medium washing device 300 instead of the filter medium washing device 200. Thus, in FIG. 3, common reference numerals are used to describe the same elements as in FIG. 1, and such common elements will not be described again herein unless otherwise necessary.

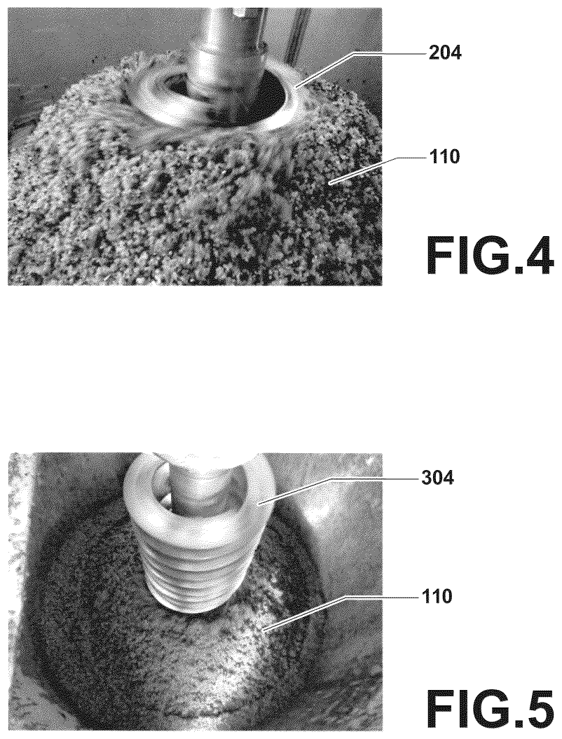

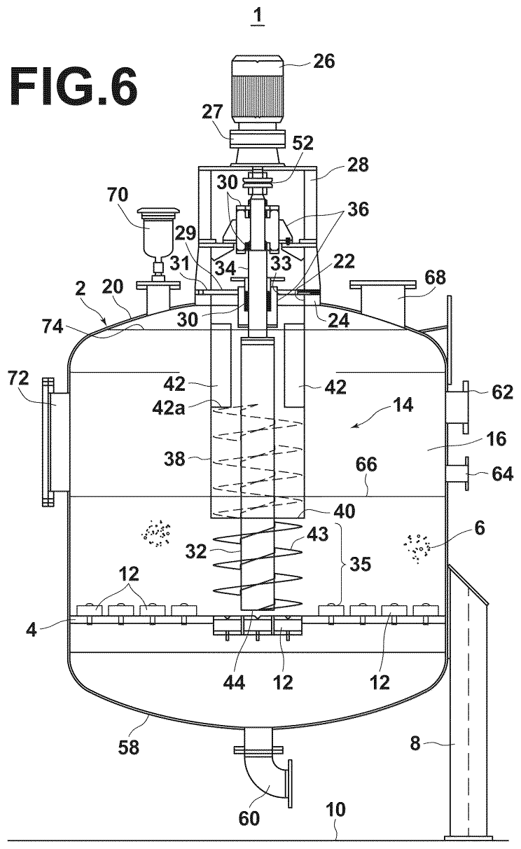

In this filter medium washing device 300, the filter medium 110 is washed in the same manner as in the filter medium washing device 200 depicted in FIG. 1. However, in the filter medium washing device 200, the screw blades 204 include two screw blades and the filter medium 110 can be transported and washed with a relatively high efficiency, but in this second embodiment, the screw blade 304 includes a single screw blade and the filter medium 110 may be transported and washed with a lower efficiency than in the first embodiment. The photographs in FIGS. 4 and 5 illustrate what the filter medium 110 actually looks like as it is transported by the screw blades 204 and 304, respectively.

Although the screw blades 204 include two screw blades in the filter medium washing device 200 in the filtration apparatus 100 of the first embodiment, but the screw blade(s) of the present disclosure may include three or more screw blades. It is to be understood that the use of a plurality of screw blades is advantageous for improving the efficiency of transporting and washing the filter medium 110 compared to using a single screw blade.

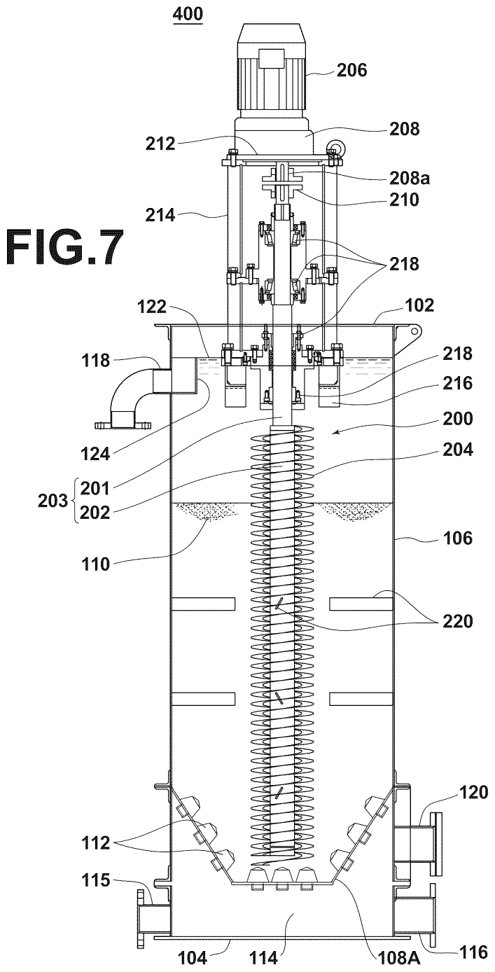

Referring now to FIG. 7, a filtration apparatus 400 according to a third embodiment of the present disclosure will be described. Thus, in FIG. 7, common reference numerals are used to describe similar elements as in FIG. 1, and such common elements will not be described again herein unless otherwise necessary. This filtration apparatus 400 differs from the filtration apparatus 100 according to the first embodiment in FIG. 1 basically only in that a filter bed 108A of the filtration apparatus 400 has a different shape. Specifically, the filtration apparatus 100 of the first embodiment uses the filter bed 108 having a simple precise circular shape, whereas the filter bed 108A in the filtration apparatus 400 of this embodiment has a “funnel” or “mortar” shape, which is an upward concave shape that has an outer peripheral surface having a precise circular shape and gradually decreases in diameter downward and toward the center.

By forming the filter bed 108A into such a shape, the filter medium 110 that have been scrubbed and washed as they have been transported upward by the rotating screw blades 204 of the filter medium washing device 200 as well as the contaminants that have been separated from the filter medium 110 and expected to be discharged from the treated water outlet pipe 118 are likely to be naturally collected near the lower ends of the screw blades 204. This allows for more efficient scrubbing and washing of the filter medium 110 and discharge of contaminants.

In this embodiment, the filter bed 108A provides a larger contact area between the unfiltered raw water and the filter medium 110 than the, precise circular, filter bed 108, and is therefore also advantageous for speeding up the filtration process.

As has been described herein, in the present disclosure, the backflow washing (backwashing) as described above may be performed. In conjunction with or alternatively to the backwashing, bubble washing of the filter medium may be performed. The bubble washing process includes directing bubble washing water containing a large number of fine bubbles into the layer of filter medium 110 from below. During the bubble washing process, the bubble washing water flows through the pieces of the filter medium 110, and the contaminants trapped on the surface of each piece of the filter medium 110 are separated off by the vibration, impact, and contact caused by the bubbles passing through the filter medium 110. The bubble washing water containing the contaminants thus separated is discharged from the filtration tank 106 through the treated water outlet pipe 118, as in the case of backwashing.

Performing the bubble washing described above in conjunction with backwashing allows for a more effective cleaning of the filter medium 110. The bubble washing also helps reduce the use of backwash water, making it an effective way to reduce backwash water consumption. The water used to make bubble washing water may be prepared by diverting a portion of the backwash water, or it may be prepared separately from the backwash water. To introduce a large number of fine bubbles into the water for the bubble washing water, a non-positive displacement pump configured to rotate the impeller in its casing may be used to pump water into the filter medium 110. The non-positive displacement pump uses the impeller to stir water and produce bubbles in the water. Alternatively, if it is desired to produce finer bubbles than those referred to as fine bubbles or microbubbles, a special bubble generator designed to produce such finer bubbles may be placed in the water pump path.

### EXPLANATION OF THE REFERENCE NUMERALS

100, 150, 400 filtration apparatus
102 top member of the filtration tank
104 bottom wall of the filtration tank
106 filtration tank
108, 108A filter bed
110 filter medium
112 strainer
114 raw water inflow chamber
115 raw water inlet pipe
116 backwash water inlet pipe
118 treated water outlet pipe
120 filter medium discharge port
122 treated water
124 weir plate
200, 300 filter medium washing device
203 rotary axis
204, 304 screw blade
206 motor
208 reduction gear mechanism
210 joint
212 retaining member
214, 216 support
218 bearing
220 filter medium flow prevention plate

1. A filtration apparatus comprising:
a filtration tank;
a layer of filter medium disposed in an interior of the filtration tank, the layer of filter medium being used to pass supplied raw water therethrough from bottom to top to filter the raw water; and
a filter medium washing device having a helical screw placed upright in the layer of filter medium and a screw driving unit configured to rotate the screw about the axis of the rotation thereof, the filter medium washing device being configured to rotate the screw to scrub and wash the filter medium,
wherein the filter medium washing device is further configured to transport the filter medium upward in a state in which an outer peripheral edge of the screw is in direct contact with the layer of filter medium, and
wherein the raw water is filtered at a filtration flow rate of 10 to 40 m/h.

2. The filtration apparatus according to claim 1, wherein the screw includes a plurality of helical screw parts arranged in the direction of the axis of rotation with one or more spaces therebetween.

3. The filtration apparatus according to claim 1, wherein the screw has a coil spring shape.

4. The filtration apparatus according to claim 2, wherein the screw has a coil spring shape.
